(19) United States
(12) Patent Application Publication
(10) Pub. No.: US 2006/0017789 A1
(43) Pub. Date: Jan. 26, 2006

(54) Inkjet printer cartridge refilling machine and method of operation thereof

(76) Inventors: David Fletcher, Essex (GB); John Henderson Gorrod, Hampshire (GB); Derek Lupton, Bristol (GB)

Correspondence Address: MATHEWS, SHEPHERD, MCKAY, & BRUNEAU, P.A., 100 THANET CIRCLE, SUITE 306, PRINCETON, NJ, 08540, US

(21) Appl. No.: 11/143,239

(22) Filed: Jun. 2, 2005

(30) Foreign Application Priority Data
Jul. 23, 2004 (GB) 0416443.0

(51) Int. Cl. B41J 2/175

(52) U.S. Cl. 347/85

(57) ABSTRACT

An inkjet printer cartridge refilling machine (1) is provided comprising first mounting means (18) on which an empty printer cartridge can be mounted, nozzle means (12) adapted to extend into the printer cartridge and deliver ink to the printer cartridge, a second mounting means (23) adapted to releasably mount a cassette (29) containing ink of the specific type and volume required to refill the empty printer cartridge, the arrangement being such that the cassette (29), when mounted on the machine (1), is connected to the nozzle means (12), the machine (1) being operative to deliver ink from the cassette (29) to the printer cartridge to refill the printer cartridge. A method of refilling an ink cartridge, and an ink cassette are also provided.

The present invention relates to an inkjet printer cartridge re-filling machine and method of operation thereof.

### BACKGROUND OF THE INVENTION

It has previously been proposed to provide a machine for refilling substantially empty inkjet printer cartridges to enable the cartridges to be reused. Such cartridges typically have specific dimensions and external features specific to the manufacturer and the specific type of printer with which the cartridge is to be used. Importantly each cartridge will only operate successfully when filled with ink specific to the type of cartridge concerned. For example one cartridge of one manufacturer may require ink having different properties to ink required for a cartridge of another manufacturer. In addition one cartridge from one manufacturer may require a different type and volume of ink to another cartridge from the same manufacturer. The position of the chamber of each colour of ink may vary from one type of cartridge to another. In a retail situation it is desirable to be able to refill a plurality of different cartridges from different manufacturers relatively quickly. In many cases, it is desirable to be able to refill the customer's own cartridge while he/she waits. Once the customer's cartridge has been refilled a predetermined number of times, a new cartridge has to be purchased.

Prior ink cartridges include so called print head cartridges wherein the print head, controlling electronics and the ink chamber are all part of one removable unit. Often such ink cartridges have a similar shape but have dissimilar ink formulation, firing sequences or electrical circuitry.

Ink type can vary between different types of ink cartridge, some may, for example, use pigmented ink, others dye based ink, others photo quality ink. Often the different ink types are incompatible.

The above problems are particularly prevalent in the retail environment because of the relatively large number of different types of ink/toner cartridges that may need refilling.

Previous machines have comprised a plurality of ink nozzles each of which is connected to a respective, relatively large, supply of ink specific to a particular cartridge. The machine stores a number of these relatively large supplies of ink to account for the large variety of inkjet cartridges available. When a cartridge is required to be refilled by a particular nozzle of a type matching the cartridge concerned, the pipe work connecting the nozzle to the ink supply is first flushed out to avoid cross contamination with ink not compatible with the cartridge being refilled. The pipe work from that nozzle is then connected to a supply of ink suitable to refill the cartridge concerned. Ink is then pumped from the specific ink supply until the cartridge is refilled, after which the cartridge is removed. This process is relatively lengthy because of the flushing and reconnection steps. If another, different cartridge is to be refilled using the same nozzle (there being a space and cost based limit on how many nozzles can be provided), the pipes have again to be flushed and reconnected. Such machines, because of the large number of ink supplies required, are typically relatively large, unwieldy and time-consuming to operate.

To overcome this requirement of flushing and reconnection to different ink supplies, machines have been proposed which use what is commonly known as universal ink such that a plurality of different cartridge types are refilled with the same composition of ink. Whilst this process can be flexible and easy to operate, the use of such universal ink is generally considered to be unsatisfactory in terms of achieving consistent and reliable performance of the refilled ink cartridge.

### SUMMARY OF THE INVENTION

According to a first aspect of the invention there is provided an inkjet printer cartridge refilling machine comprising first mounting means on which an empty printer cartridge can be mounted, nozzle means adapted to extend into the printer cartridge and deliver ink to the printer cartridge, a second mounting means adapted to releasably mount a cassette containing ink of the specific type and volume required to refill the empty printer cartridge, the arrangement being such that the cassette, when mounted on the machine, is connected to the nozzle means, the machine being operative to deliver ink from the cassette to the printer cartridge to refill the printer cartridge.

By printer cartridge we mean any ink or toner cartridge as used, for example, on printers, fax machines and photocopiers.

Preferably the first and second mounting means and the nozzle means form a module which is itself adapted to be removably mounted on the machine.

Preferably the machine comprises a plurality of modules.

Preferably the nozzle means of each module comprises a first set of nozzles adapted to be inserted into the cartridge to be refilled, and a second set of nozzles adapted to be inserted into the cassette, the two sets of nozzles being in communication with one another.

Preferably at least one of the modules of each machine is adapted to refill cartridges of a different type to that of another module. Preferably the first set of nozzles of different modules are specific to a particular type of cartridge and thus differ between modules, whilst the second set of nozzles of different modules are preferably substantially identical, the cassettes also being substantially identical.

Preferably at least one of the first set of nozzles and the first mounting means are movably mounted on the module to permit relative movement between the first set of nozzles and the first mounting means such that the first set of nozzles can enter the cartridge to be refilled.

Preferably at least one of the first set of nozzles and the first mounting means are mounted on a carriage slidably mounted on the module.

Preferably movement of the carriage is effected by a user operated handle on the carriage.

Preferably at least one of the second set of nozzles and the second mounting means are movably mounted on the module to permit relative movement between the second set of nozzles and the second mounting means such that the second set of nozzles can enter the cassette.

Preferably at least one of the second set of nozzles and the second mounting means are mounted on a carriage slidably mounted on the module.

Preferably movement of the carriage is effected by a user operated mechanism on the carriage. Most preferably the mechanism comprises part of the second mounting means that is operative when a cassette is mounted on the second mounting means by a user.

Preferably the machine comprises pump means operative, in use, to pump ink from the cartridge to be refilled, and to pump fresh ink from the cassette to the cartridge.

Preferably the pump means comprises at least one peristaltic pump.

Preferably each module comprises control means operative to automatically control the operation of the pump means upon receipt of a user generated control signal.

The control means preferably comprises a programmable memory, for example an EPROM.

The control means preferably further comprises a display indicative of the program selected by the user.

Preferably the display is a touch screen display.

According to a second aspect of the invention there is provided a method of refilling an inkjet printer cartridge comprising an ink cassette that contains a single charge of ink or inks of sufficient volume/s to refill the printer cartridge, bringing the printer cartridge relatively into co-operation with a nozzle means, removing ink from the cassette through nozzle means, and supplying the nozzle means, whilst the nozzle means is co-operating with the cartridge, with ink from the cassette so as to replenish the cartridge.

Preferably the step of removing ink comprises activating pump means to pump old ink from the printer cartridge and into ink disposal means.

Preferably the supplying step comprises moving the second set of nozzles and/or the cassette such that the second set of nozzles enters a region of predetermined weakness of the cassette to such an extent that the nozzle inlets are adjacent with the base of the cassette.

Preferably the nozzle inlets are adjacent to the recess at the base of the cassette.

Preferably means are provided operative to control the pump means such that only the amount of ink required to fill the printer cartridge is pumped from the cassette.

Preferably the method further comprises a cartridge priming step wherein ink from the refilled cartridge is drawn out of the print head of the cartridge to induce flow of the ink from the cartridge.

Preferably the method further comprises a final evacuation step wherein after the refilled cartridge has been removed, the pump means pumps ink residual in the nozzle means out of the nozzle means and back into the cassette.

According to a third aspect of the invention there is provided an ink cassette for use with the machine of the first aspect of the invention, the cassette comprising at least one chamber to receive and contain sufficient ink to refill an empty inkjet printer cartridge, and means to enable the cassette to be removably mounted on the machine.

Preferably the cassette comprises a plurality of ink chambers.

Preferably the or each chamber comprises a sealed chamber having a region of predetermined weakness positioned so as to be aligned with the second set of nozzles when the cassette is mounted on the machine so that the second set of nozzles, in use of the machine, extend through the region of predetermined weakness.

Preferably the region of predetermined weakness comprises an aperture sealed by a portion of sheet material. Preferably the material is a pierceable plastics sheet material. The sheet material may comprise a metallic foil or silicone compound or any other suitable pierceable and sealable material.

Preferably the or each chamber comprises a base provided with a recess that in use of the cassette comprises the lowermost part of the chamber of the cassette.

Preferably the region of predetermined weakness is positioned on the ceiling of the chamber so as to be opposed to the base and the recess such that when the cassette is mounted on the machine the recess is lowermost such that ink contained in the cassette flows under the influence of gravity into the recess.

Most preferably when the cassette is mounted on the machine, at least one nozzle of the second set of nozzles is aligned with the recess. Preferably each nozzle is aligned with a respective recess.

Other aspects of the present invention may include any combination of the features or limitations referred to herein.

### DESCRIPTION OF THE DRAWINGS

The present invention may be carried into practice in various ways, but embodiments will now be described by way of example only with reference to the accompanying drawings in which:

FIG. 1 is a perspective view of a printer inkjet refilling machine in accordance with the present invention;

FIG. 2 is a side view of a module comprising part of the machine of FIG. 1;

FIG. 3a is an enlarged perspective view of the module of FIG. 2;

FIG. 3b is an enlarged front view of part of the module of FIGS. 2 and 3a.

FIG. 4 is a rear view of the module of FIGS. 2 and 3;

FIG. 5 is a schematic side view of the rear of the module of FIGS. 2 to 4;

FIG. 6 is a perspective view of an ink cassette in accordance with the present invention; and

FIG. 7 is a side view of the cassette of FIG. 6.

### DETAILED DESCRIPTION OF THE INVENTION

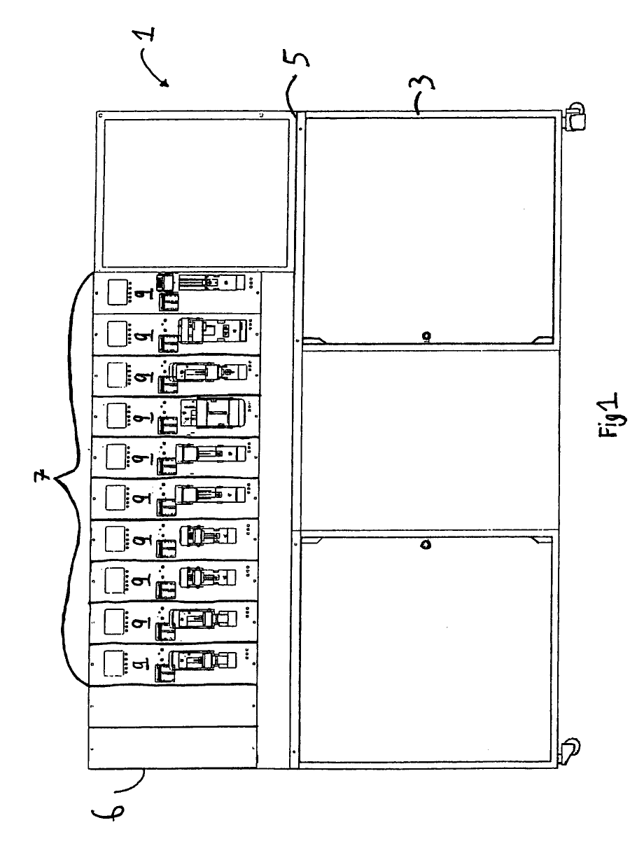

Referring initially to FIG. 1, a inkjet printer cartridge refilling machine 1 comprises an oblong storage cabinet 3 and a back plate 5 comprising a hollow, oblong, open-fronted box 6 on which is mounted a plurality of refilling modules 7. Any number of modules 7 may be provided so as to extend, if necessary, from one side margin of the back plate 5 to the other. The cabinet 3 could be made from any suitable material including sheet metal.

The function and programming of each module 7 is controlled by separate printed circuit boards (PCBs—not shown) located at the back of each module 7. The PBCs can control, inter alia, the amount of ink to be dispensed, emptying cycles and the operation and timing of pump means.

In addition each PCB is interconnected into a single line which exits the machine into a diagnostic plug (not shown). By connecting a separate computer to the diagnostic plug, a user may re-programme any or all of the modules 7 to change, for example, filling or emptying parameters.

In addition, if required in a retail environment, the diagnostic plug can be used to count the number of re-fills each module 7 completes at the end of a certain period, for stock take, revenue reconciliation or other accountancy and control purposes.

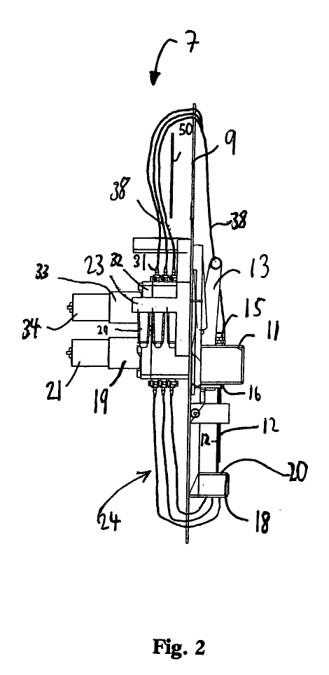

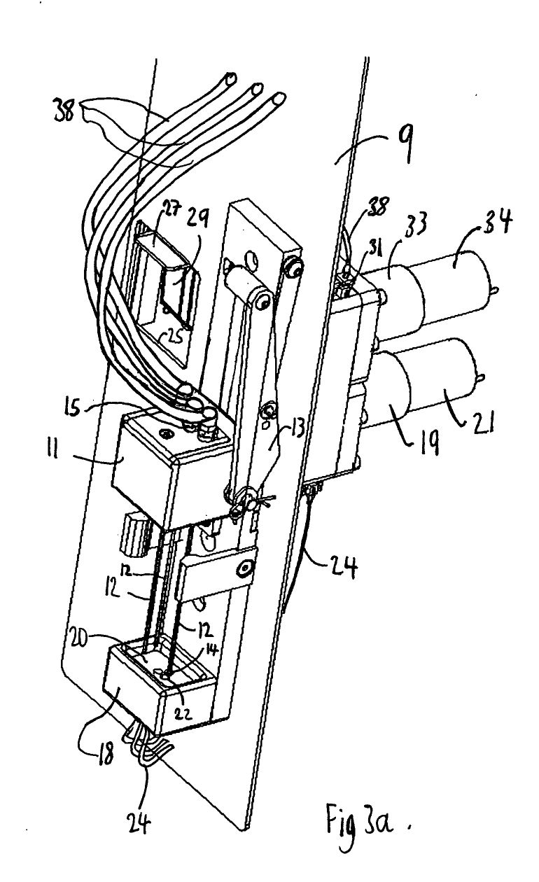

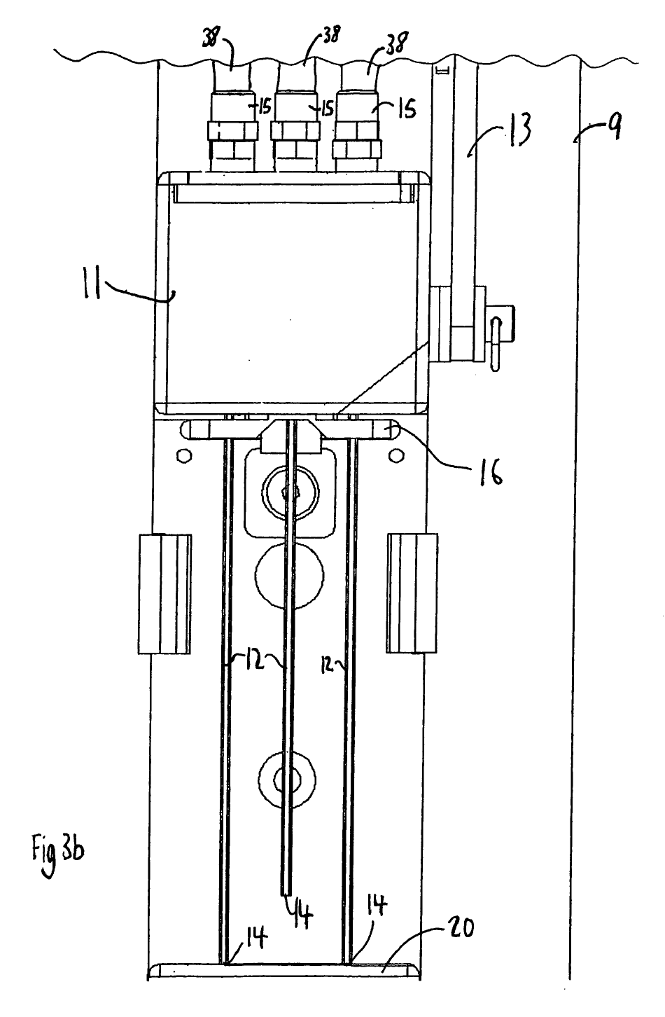

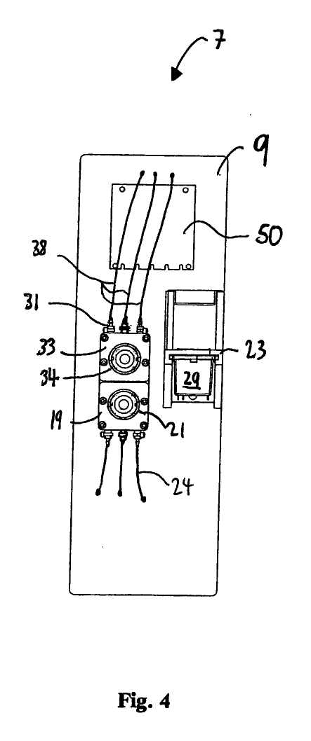

Referring additionally to FIGS. 2 to 5 each module 7 comprises a mounting plate 9 adapted to be removably secured to the open front of the box 6 using any suitable method which, for example, may comprise a quick release attachment mechanism as is well known.

A carriage 11 extends perpendicularly from the front side of the plate 9. The carriage 11 is slidably mounted on the plate 9 so as to be able to move up and down the front of the plate 9. A handle 13 is provided to facilitate this movement, the handle 13 being connected to the carriage 11 by a suitable linkage operative to raise the carriage 11 as the handle 13 is lowered and vice versa.

Three ink injector nozzles 12 extend from the carriage 11 through the base of the carriage 11. A planar guide plate 16 is provided beneath the carriage 11 through which the nozzles 12 extend to help maintain the relative spacing of the nozzles 12.

Three ink nozzle connectors 15 are mounted on the top of the carriage 11 and are each in fluid communication with a respective one of the injector nozzles 12.

A printer cartridge receiving box 18 is located on the plate 9 below the carriage 11 and the nozzles 12 and comprises a recessed upper support surface 20. A printer cartridge to be refilled is, in use, placed on support surface 20 of the box 18. The box 18 and the support surface 20 are of a size and shape specific to correspond to the print head of the particular type of cartridge to be refilled and is such that when the cartridge is mounted in the box 18, a preformed refilling aperture at the base of each ink chamber of the cartridge is aligned with a respective ink injector nozzle 12.

The support surface 20 and the base of the box 18 are formed with a number of drainage apertures 22, the number usually corresponding to the number of ink chambers provided in the cartridge. Each drainage aperture 22 in the base of the box 18 is connected to a respective drainage pipe 24 that is connected to pump means comprising a peristaltic pump 19 driven by a DC electric motor 21. The pump 19 is in communication with an ink disposable receptacle (not shown) in which unwanted ink can be stored for disposal.

The cartridge is mounted on the box 18 with the print head lowermost so as to be in contact with support surface 20, and the base of the cartridge uppermost so that the refilling apertures are adjacent respective ink injector nozzle 12. When so mounted, the print head of the cartridge is adjacent the drainage apertures 22 in the support surface 20.

When the handle 13 is raised, the injector nozzles 12 are lowered with the carriage 11 such that the injector nozzles 12 extend into the printer cartridge. This is the position shown in FIGS. 2 to 4 although the cartridge itself has been omitted for clarity. When the carriage 11 is in the uppermost position, the injector nozzles 12 do not extend into the cartridge and the cartridge can be removed and replaced with another cartridge.

A support frame 23 is mounted on the rear face of the plate 9 and an aperture 25 is formed in the plate 9 so as to be aligned with the frame 23. A closure comprising a door 27 of any suitable type including, for example, a sliding of L-shaped cross-section is provided to close the frame 23. The frame 23 is dimensioned to receive an ink cassette 29 which functions as a supply of fresh ink of the type and volume required by the specific printer cartridge to be refilled.

A second set of connecting nozzles 31 are provided on a carriage 32 slidably mounted on the rear face of the mounting plate 9, each of the connecting nozzles 31 terminating in a respective ink receiving needle 37. The carriage 32 is movable to a position in which the needles 37 extend into the cassette 29 via a needle guide 40.

The nozzles 31 are connected, via suitable pipe work 38 to pump means comprising a peristaltic pump 33 driven by a DC electric motor 34. The other side of the pump 33 is connected, to the connectors 15 on the carriage 11 that feed the printer cartridge. The carriage 32 is connected to the door 27 or the frame 23 by a suitable linkage operative such that as the door 27 is closed, the linkage moves the carriage 32 downwardly such that the ink receiving needles 370 enter the cassette 29.

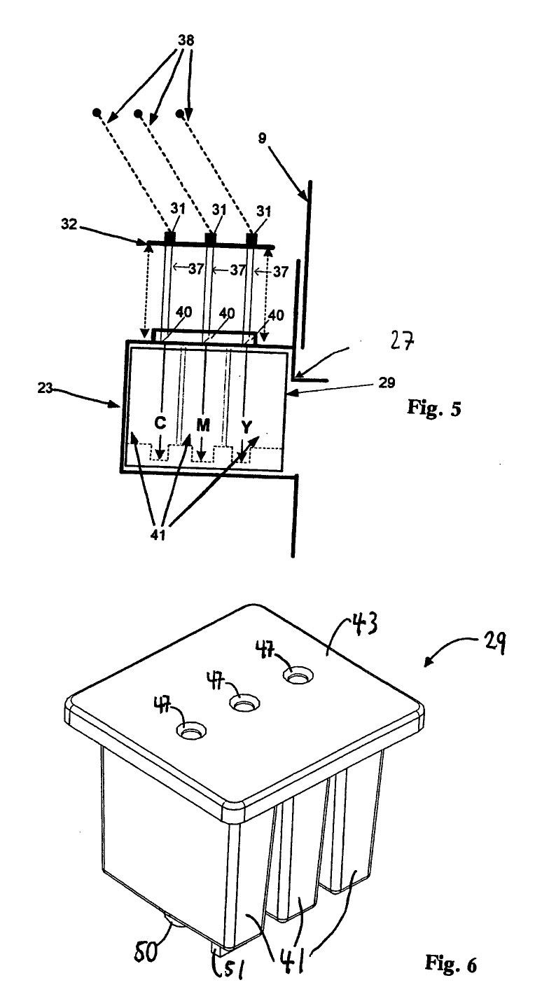

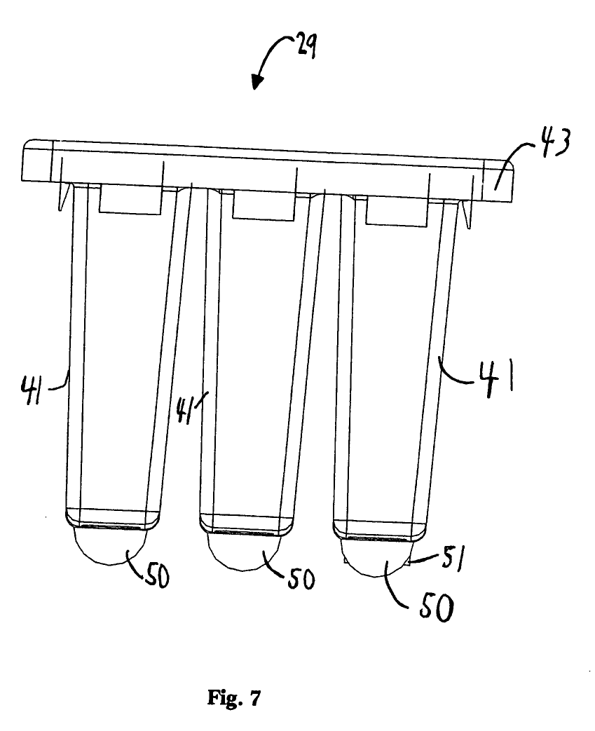

Referring additionally to FIGS. 6 and 7, the ink cassette 29 comprises, in this example, three adjacent, substantially oblong chambers 41 that are sealed by a planar lid 43. The lid 43 comprises three circular apertures 47 that are positioned, when the lid 43 is mounted on the cassette 29 and the cassette 29 is received in the box 23, to be aligned with a respective one of the needles 37 of the second set of nozzles 31. Prior to use, the apertures 47 of the lid 43 are sealed closed using, for example, a strip or foil of adhesive backed material (not shown). The material can be any suitable material including, for example, a plastics material, a silicone compound, a metal foil material or an adhesive backed paper material. Thus the apertures 47 and the sealing strip together comprise a region of predetermined weakness adapted to be pierced by the needles 37. The region of predetermined weakness could be provided by any other suitable means including, for example, serrations or partial cuts in the lid 43.

The base of each chamber 41 of the cassette 29 is formed with a respective hemispherical recess 50 that comprises the lowermost part of that chamber 41 and is therefore the part of the cassette 29 to which any ink contained in the chamber 41 will flow under the influence of gravity when the cassette 29 is mounted on the machine 1.

The base of one of the chambers 41 of the cassette 29 is formed with a male lug 51 that projects outwardly of the cassette 29. This lug 51, in use, is received in a corresponding female formation provided on the box 23 which ensures that the cassette 29 is inserted into the box 23 in the correct orientation. This is to ensure that the chambers 41 of the cassette 29 are, in use, in communication with the correct nozzles 31 to avoid any ink cross contamination as each ink chamber 41 may contain ink of a different colour, type or composition.

It will be appreciated that the cassette 29 could comprise any number of chambers 41, including only one chamber 41, so as to correspond to the number of ink chambers 41 provided in the cartridge to be refilled.

Control means 50 are provided to control the operation of the carriages 11, 32 and the pumps 19, 33. The control means 50 can comprise any suitable means including, for example, an electronic data processor comprising a printed circuit board or boards. A display, which may be an LCD display, or an LED display, can be provided to indicate information concerning the operation or status of the machine 1. The display may be a touch screen display operative to enable the user to start, stop or monitor the machine 1.

In use, a user places the cartridge to be refilled in the box 18 on the front of the plate 9 with the print head of the cartridge resting on the support surface 20. The handle 13 is initially in the lowermost position such that the carriage 11 and the injector nozzles 12 are spaced above the box 18 and the top of the cartridge. The refilling apertures 22 of the cartridge (not shown) are aligned with respective ink injector nozzles 12. The user then inserts a cassette 29 onto the frame 23 and closes the door 27, the lug 51 on the cassette 29 providing a physical barrier to this insertion if the user attempts to insert the cassette 29 in an incorrect orientation.

The number of chambers 41 of the cassette 29 correspond to the number of inks required to fill the cartridge. Each chamber 41 of the cassette 29 also contains ink of a type and volume specifically corresponding to the type of ink required by the specific type of ink cartridge to be refilled. Indicia may be provided on the cassette 29 indicative of the type of cartridge that can be refilled by that particular cassette 29.

The user then raises the handle 13 which lowers the first carriage 11 downwardly such that the ink injector nozzles 12 enter respective chambers of the ink cartridge. Switch means may be provided to complete a circuit when the handle 13 is fully lowered so as to activate the emptying and refilling cycle and other pre-programmed cycles.

The first pump 19 is then activated by the control means 50 to draw ink remaining in the cartridge out of the cartridge, through the drain apertures 22 and pipe work 24, into the pump 19 and into the ink disposal receptacle mounted elsewhere in the machine. Sensor means may be provided to determine when sufficient ink has been drawn out of the cartridge. This is to ensure that when the refilling operation is complete, substantially only fresh ink is contained in the cartridge.

The second carriage 32 has already been lowered towards the cassette 29 as the door 27 to the aperture 25 was closed. The carriage 32 is lowered to such an extent that respective ink receiving needles 37 pierce the foil sealing each cassette chamber 41 and enter the respective chambers 41. The carriage 32 is lowered until the tip of the needles 37 are adjacent the lowermost point in each chamber 41, namely the lowermost point of each recess 50.

The second pump 37 is then activated by the control means 50 to draw fresh ink out of the cassette 29, through the ink receiving needles 37, through the connecting pipe work 38, through the connectors 15, through the nozzles 12 and into the cartridge 20. Means are provided to determine when the cartridge is full or substantially full. This may be achieved by sensing the volume of ink pumped through the connecting pipe work 38 or through the valve arrangement and ensures that the volume of ink pumped into the cartridge does not exceed the cartridge ink capacity.

When the cartridge is sufficiently refilled the second pump 33 is deactivated.

The control means 50 then begins a priming cycle to induce ink flow from the cartridge print head. This helps ensure that ink will flow from the cartridge when the cartridge is used in a printer later on. This is achieved by reactivating the pump 19 so as to draw fresh ink from the cartridge, through the drainage apertures 22 of the cartridge, and through the pipe work 24 to induce ink flow from the refilled cartridge. Once primed the printer cartridge head is sealed to prevent further ink flow until the cartridge is used in a printer.

After the above priming steps, the pump 33 is reactivated to pump any ink residual in the ink injector nozzles 12, the pipe work 38, the connectors 15 and the connecting nozzles 31 back into the cartridge 29.

This ensures that the ink receiving needles 37 and pipe work 38 are substantially free of ink before beginning the above process again with another empty cartridge. This removes static ink from the pipe work 38.

A number of different modules 7 can be provided on the machine 1. Each module may have first set of nozzles 12 specific to fit a particular type, size and shape of cartridge. The shape and dimensions of the cassette 29 may be the same for each module 7 or may be different depending upon the number of different types of ink required to refill the cartridge concerned, and the volume of ink required. The shape and size of the box 18 and the support surface 20 may be different for different modules 7 so as to correspond to the specific size and shape of the print head of the cartridge to be refilled using each specific module.

The machine 1 provides a substantially automated, easy to use and relatively quick method of refilling a wide variety of different models of empty or partially empty printer inkjet cartridges at a point of sale or retailer environment. Through the use of cassettes 29 it allows the machine operator to substantially and easily switch between various ink compositions without the requirement for additional and complex ink feeding systems or the necessity to flush out such systems prior to a specific or individual cartridge refilling process commencing.

FIG. 1 above shows one form of the machine comprising ten modules 7 in a cabinet 3 which is approximately two metres long and weighs approximately a quarter ton. This cabinet 3 is a sheet metal vehicle for the modules 7.

Alternative arrangements for mounting the modules 7 are envisaged, for example, as follows:

A five module relatively small machine could be provided for photo cartridge use only. This may be mounted on a table or a check out counter, and could, for example, be in a carousel form in the shape of a pentagon, which can be rotated depending upon the modules 7 in use.

A twelve module machine could be provided wherein the modules 7 are arranged in a back to back formation. Such a machine would fit, for example, within a one metre squared floor space and could comprise a lower cabinet and two rows of six modules 7 sitting back to back on the lower cabinet. The operator can walk around the machine depending upon which modules 7 are in use.

A rotating carousel type machine for twelve modules 7 standing on its own base could be provided. This would be designed to stand in the centre floor of a busy shop, rather like a revolving postcard display.

A starter machine could be provided for, for example, six modules 7, which could be built up on a modular basis two modules 7 at a time. This would be a smaller machine designed to have more modules 7 bolted on as the retailer's business grows.

A wall mounted machine could be provided. Up to twelve modules 7 could be wall mounted, perhaps in one long straight row, or mounted in a stacked formation of two rows of six modules 7. In this way modules 7 could be put into premises where floor space is very limited.

What is claimed is:

1. An inkjet printer cartridge refilling machine comprising first mounting means on which an empty printer cartridge can be mounted, nozzle means adapted to extend into the printer cartridge and deliver ink to the printer cartridge, and a second mounting means adapted to releasably mount a cassette containing ink of the specific type and volume required to refill the empty printer cartridge, the arrangement being such that the cassette, when mounted on the machine, is connected to the nozzle means, the machine being operative to deliver ink from the cassette to the printer cartridge to refill the printer cartridge.

2. The inkjet printer cartridge refilling machine of claim 1 wherein the first and second mounting means and the nozzle means form a module which is itself adapted to be removably mounted on the machine.

3. The inkjet printer cartridge refilling machine of claim 2 wherein the machine comprises a plurality of modules.

4. The inkjet printer cartridge refilling machine of claim 2 wherein the nozzle means of the or each module comprises a first set of nozzles adapted to be inserted into the cartridge to be refilled, and a second set of nozzles adapted to be inserted into the cassette, the two sets of nozzles being in communication with one another.

5. The inkjet printer cartridge refilling machine of claim 3 wherein at least one of the modules of each machine is adapted to refill cartridges of a different type to that of another module.

6. The inkjet printer cartridge refilling machine of claim 5 wherein the first set of nozzles of different modules are specific to a particular type of cartridge and thus differ between modules, whilst the second set of nozzles of different modules are preferably substantially identical, the cassettes also being substantially identical.

7. The inkjet printer cartridge refilling machine of claim 4 wherein at least one of the first set of nozzles and the first mounting means are movably mounted on the module to permit relative movement between the first set of nozzles and the first mounting means such that the first set of nozzles can enter the cartridge to be refilled.

8. The inkjet printer cartridge refilling machine of claim 7 wherein at least one of the first set of nozzles and the first mounting means are mounted on a carriage slidably mounted on the module.

9. The inkjet printer cartridge refilling machine of claim 8 wherein movement of the carriage is effected by a user operated handle on the carriage.

10. The inkjet printer cartridge refilling machine of claim 4 wherein at least one of the second set of nozzles and the second mounting means are movably mounted on the module to permit relative movement between the second set of nozzles and the second mounting means such that the second set of nozzles can enter the cassette.

11. The inkjet printer cartridge refilling machine of claim 10 wherein at least one of the second set of nozzles and the second mounting means are mounted on a carriage slidably mounted on the module.

12. The inkjet printer cartridge refilling machine of claim 11 wherein movement of the carriage is effected by a user operated mechanism on the carriage.

13. The inkjet printer cartridge refilling machine of claim 12 wherein the mechanism comprises part of the second mounting means that is operative when a cassette is mounted on the second mounting means by a user.

14. The inkjet printer cartridge refilling machine of claim 1 wherein the machine comprises pump means operative, in use, to pump ink from the cartridge to be refilled, and to pump fresh ink from the cassette to the cartridge.

15. The inkjet printer cartridge refilling machine of claim 14 wherein the pump means comprises at least one peristaltic pump.

16. The inkjet printer cartridge refilling machine of claim 14 wherein each module comprises control means operative to automatically control the operation of the pump means upon receipt of a user generated control signal.

17. The inkjet printer cartridge refilling machine of claim 16 wherein the control means comprises a programmable memory, for example an EPROM.

18. The inkjet printer cartridge refilling machine of claim 17 wherein the control means further comprises a display indicative of the program selected by the user.

19. The inkjet printer cartridge refilling machine of claim 18 wherein the display is a touch screen display.

20. A method of refilling an inkjet printer cartridge comprising an ink cassette that contains a single charge of ink or inks of sufficient volume/s to refill the printer cartridge, bringing the printer cartridge relatively into co-operation with a nozzle means, removing ink from the cassette through nozzle means, and supplying the nozzle means, whilst the nozzle means is co-operating with the cartridge, with ink from the cassette so as to replenish the cartridge.

21. The method of claim 20 wherein the step of removing ink comprises activating pump means to pump old ink from the printer cartridge and into ink disposal means.

22. The method of claim 20 wherein the supplying step comprises moving the second set of nozzles and/or the cassette such that the second set of nozzles enters a region of predetermined weakness of the cassette to such an extent that the nozzle inlets are adjacent with the base of the cassette.

23. The method of claim 22 wherein the second set of nozzles are moved to such an extent that the nozzle inlets are adjacent to the recess at the base of the cassette.

24. The method of claim 21 further comprising means operative to control the pump means such that only the amount of ink required to fill the printer cartridge is pumped from the cassette.

25. The method of claim 20 wherein the method further comprises a cartridge priming step wherein ink from the refilled cartridge is drawn out of the print head of the cartridge to induce flow of the ink from the cartridge.

26. The method of claim 20 wherein the method further comprises a final evacuation step wherein after the refilled cartridge has been removed, the pump means pumps ink residual in the nozzle means out of the nozzle means and back into the cassette.

27. An ink cassette for use with the machine of the first aspect of the invention, the cassette comprising at least one chamber to receive and contain sufficient ink to refill an empty inkjet printer cartridge, and means to enable the cassette to be removably mounted on the machine.

28. The ink cassette of claim 27 wherein the cassette comprises a plurality of ink chambers.

29. The ink cassette of claim 27 wherein the or each chamber comprises a sealed chamber having a region of predetermined weakness positioned so as to be aligned with the second set of nozzles when the cassette is mounted on the machine so that the second set of nozzles, in use of the machine, extend through the region of predetermined weakness.

30. The ink cassette of claim 29 wherein the region of predetermined weakness comprises an aperture sealed by a portion of sheet material.

31. The ink cassette of claim 30 wherein the material is a pierceable plastics sheet material.

32. The ink cassette of claim 27 wherein the or each chamber comprises a base provided with a recess that in use of the cassette comprises the lowermost part of the chamber of the cassette.

33. The ink cassette of claim 32 wherein the region of predetermined weakness is positioned on the ceiling of the chamber so as to be opposed to the base and the recess such that when the cassette is mounted on the machine the recess is lowermost such that ink contained in the cassette flows under the influence of gravity into the recess.

34. The ink cassette of claim 32 wherein when the cassette is mounted on the machine, at least one nozzle of the second set of nozzles is aligned with the recess.

35. The ink cassette of claim 34 wherein each nozzle is aligned with a respective recess.
